(19) United States
(12) Patent Application Publication
(10) Pub. No.: US 2015/0047576 A1
(43) Pub. Date: Feb. 19, 2015

(54) Grooming Tool

(71) Applicant: Cheryl Marie Dauphin, Wethersfield, CT (US)

(72) Inventor: Cheryl Marie Dauphin, Wethersfield, CT (US)

(21) Appl. No.: 14/460,063

(22) Filed: Sep. 2, 2014

(51) Int. Cl. A01K 13/00

(52) U.S. Cl. CPC A01K 13/001; A01K 13/002
USPC 119/633

(57) ABSTRACT

A grooming tool comprises a blade and a solid wooden handle, wherein said blade is contained within the solid wooden handle. The blade of the grooming tool may be a bi-metal blade, wherein said blade is pressure fitted into a slot in the solid wooden handle. The blade of the grooming tool may be a rubber blade that is permanently attached to said solid wooden handle by insertion of epoxy into said slot in said solid wooden handle.

### FIELD OF THE INVENTION

The present invention relates to grooming and, more particularly, to animal grooming.

### BACKGROUND

It is desirable to groom animals, such as horses, dogs, goats, cows and the like, to remove loose hair, dirt and dander therefrom.

### SUMMARY

According to an embodiment, a grooming tool comprises a blade and a solid wooden handle, wherein said blade is contained within the solid wooden handle.

The blade of the grooming tool may be a bi-metal blade, wherein said blade is pressure fitted into a slot in the solid wooden handle.

The blade of the grooming tool may be a rubber blade that is permanently attached to said solid wooden handle by insertion of epoxy into said slot in said solid wooden handle.

### BRIEF DESCRIPTION OF THE DRAWINGS

FIG. 1 is a dimensional perspective view of a groomer according to an embodiment;

FIG. 2 is a front profile view of the groomer of FIG. 1;

FIG. 3 is side view of the groomer of FIG. 1; and

FIG. 4 is a side view of an elongated groomer according to an embodiment.

### DETAILED DESCRIPTION

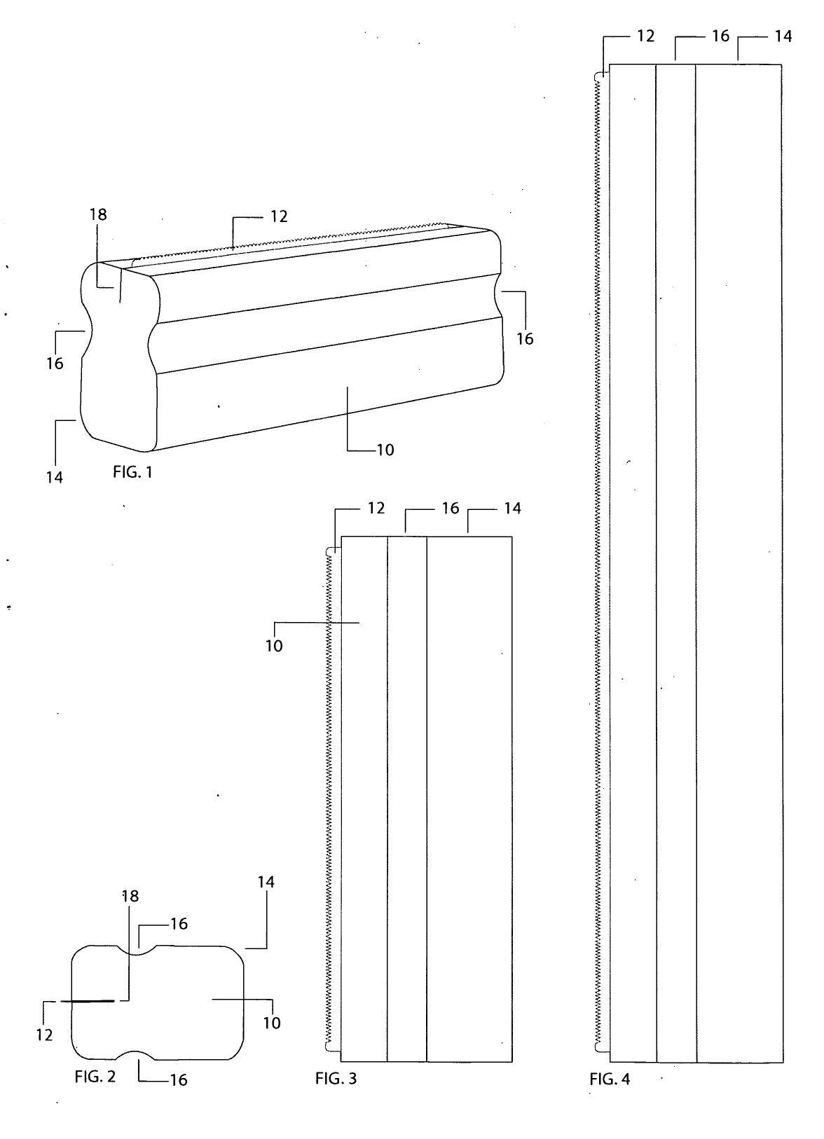

Referring to FIGS. 1-4, a groomer 10 includes a blade 12 and a handle 14. The handle 14 shall be made from solid poplar 1.625″ wide and cut down into two lengths, 5″ and 9.5″. The wooden block will then be passed through a router four times over a ½″ roundover bit in order to ease each corner along the length of all sides. Once all four corners have been rounded over, the wooden block will then be sent through the router two more times over a ½″ round nose bit in order to create the finger groove 16 that runs along the length of both sides. Finally, the wooden block will be passed through a 0.025″ kerf slotting saw that has been mounted onto a drill press in order to create the slot 18 that holds the blade 12.

The blade 12 will consist of a 10″ standard 18 tpi hacksaw blade that has been altered to fit the length of the wooden block, either 4.75″ for the 5″ handle 14, shown in FIG. 3, or 9.25″ for the 9.5″ handle 14, shown in FIG. 4.

The raw wooden handles will be prepared for finish using one coat of primer and two coats of spray paint. Once dry, the saw blade will be pressure fitted into the handle with a hammer until only ⅛″ blade is visible.

In operation, the groomer 10 will be used to remove loose hair, dirt and dander from animals including, but not limited to, horses, dogs, goats, cows. The groomer 10 will be applied to the coat and then drawn along the fur in the direction of the hair's growth to remove debris which can be removed by a force of air or by physical removal using a hand or brush.

What is claimed is:

1. A grooming tool comprising: a blade; a solid wooden handle; wherein said blade is contained within a wooden handle.

2. The grooming tool of claim 1 further comprising: bi-metal blade, wherein said blade is pressure fitted into a slot in the wooden handle.

3. The invention of claim 2 wherein a rubber blade is permanently attached to said wooden handle by insertion of epoxy into said slot in said wooden handle.
